(19) United States
(12) Patent Application Publication
(10) Pub. No.: US 2009/0030825 A1
(43) Pub. Date: Jan. 29, 2009

(54) SYSTEM AND METHOD FOR ASCERTAINING THE LEGAL DISTRIBUTION OF INTESTATE PROPERTY

(76) Inventor: KURT R. NILSON, Johnstown, PA (US)

Correspondence Address: KURT R. NILSON, 406 DIAMOND BLVD, JOHNSTOWN, PA, 15905, US

(21) Appl. No.: 12/179,754

(22) Filed: Jul. 25, 2008

Related U.S. Application Data
(60) Provisional application No. 60/951,851, filed on Jul. 25, 2007.

(51) Int. Cl. G06Q 40/00

(52) U.S. Cl. 705/35

(57) ABSTRACT

This invention generally relates to a system and method for ascertaining the legal distribution of an individual's intestate property through the use of variables created to define single points of data which are described by the appropriate body of laws as being necessary to the determination of the said legal distribution. This invention solicits and collects a minimum quantity of said data through the use of a hierarchical arrangement of the created variables, which hierarchical arrangement is ordered upon the basis of priority each variable has in relation to all remaining variables which are required by the appropriate body of laws. A report is creating and delivered to a user which details the legal distribution of the subject intestate property represented as the dollar value associated with each respective legal recipient.

### CROSS REFERENCE TO RELATED APPLICATIONS

This application claims the benefit of provisional patent application Ser. No. 60/951,851, filed Jul. 25, 2007 by the present inventor, which is incorporated by reference.

### FEDERALLY SPONSORED RESEARCH

Not Applicable

### SEQUENCE LISTING OR PROGRAM

Not Applicable

### COPYRIGHT CLAIM

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. No copyright is claimed to passages from the text of statutes reproduced.

### FIELD OF THE INVENTION

This invention generally relates to a system and method for ascertaining the legal distribution of an individual's intestate property.

### BACKGROUND OF THE INVENTION

It is commonly accepted that most Americans have not engaged in any form of planning designed to control the transfer and ownership of their property at the time of death. Although post-death ownership can be controlled through a number of relatively simple methods which are tied directly to the subject property, such as joint ownership, they involve a relinquishment of certain rights. General means for controlling the ownership of all property are also available, such as wills and trusts, but are not typically used. As a result, the post-death ownership of property must be determined following the owner's actual death without any guidance or instructions from that person.

All property that does not have legally valid, operable instructions for its ownership following the most recent owner's death is known as “intestate property.” Rather than allow intestate property to remain unowned, every American jurisdiction has its own body of laws that must be used to determine the ownership of all the intestate property that is subject to its control. In addition to the statutory intestate laws that are established by the legislature, the entire body of any jurisdiction's intestate laws may also include additional sources, such as judicial opinions that dictate the legal distribution and ownership of intestate property under specifically described circumstances.

With more than two million Americans dying every year, millions of people are also charged with the duties of determining the legal disposition and ownership of intestate property by use of these intestate laws. As expected, most people have had not received the training required to correctly research, interpret, and apply an entire written body of laws to every potential circumstance. This duty, along with all others associated with an estate settlement, are typically assumed by a family member who is appointed as the estate's personal representative.

As these matters are part of an unfamiliar process, the personal representative most often hires an attorney or accountant to provide guidance and assistance. However, aside from completing and submitting the required court forms, the personal representative often performs most of the substantive duties. These duties include simple tasks, such as canceling utilities and securing all property, as well as more involved tasks, such as gathering and accounting for all of the decedent's property and satisfying legitimate debts to the fullest extent possible. Few estates require advanced legal work as part of the estate settlement process and even fewer become involved with litigation.

With so many of these tasks being performed by the personal representative, the professional's job may be characterized as more of an advisor, particularly where there aren't any substantive legal duties required. Courts also have prescribed forms that are regularly freely provided in template format, reducing most aspects of an estate settlement to form completion tasks. Despite these circumstances, professionals are almost always retained to assist with this process.

In light of these circumstances, one of the most important tasks performed by the professional is the determination of the legal distribution the decedent's property. To complete this task, the professional must gather the subject person's unique financial and family circumstances, determine the jurisdiction or jurisdictions that control the disposition of the intestate estate, determine which components of the collected personal data are pertinent to the appropriate laws, and interpret the appropriate laws upon the basis of the subject person's individually pertinent data.

It is relatively easy to prepare books or even checklists that instruct personal representatives how to proceed with the specific tasks required to properly settle an estate, whether testate or otherwise. However, even a expansive checklist or flow diagram cannot provide the personal representative with any assurance that he or she is correctly applying the intestate laws to the unique facts and circumstances that are found with each individual estate. More importantly, these methods require the individual to independently distinguish between the information which is appropriate, required, or unnecessary.

Recently, one system has been proposed to provide financial planning and advice to living individuals upon the basis of family and financial data entered during the individual's lifetime, followed by a post-death summary of that individual's estate based upon the information which was provided before the death. (U.S. Pat. No. 6,430,542). William J. Moran, Computer-Implemented Program for Financial Planning and Advice System, U.S. Pat. No. 6,430,542 (Aug. 6, 2002) discloses a computerized system of working with an individual during his or her lifetime for the purpose of providing individual financial advice based upon that individual's circumstances during his or her lifetime. Moran's system is limited to use with only those individuals who have engaged a relationship with an advisor prior to death and who have subsequently provided the financial and personal information requested by that advisor. The system also purports to simulate the steps required to settle that individual's estate, including a determination of that individual's legal survivors. However, nowhere does Moran teach or even suggest a method for determining which portions of the body of laws are applicable to any particular person's individual circumstances or a method of interpreting the portions of the body of laws that are determined to be applicable. In that same regard, Moran does not teach or consider a method for obtaining personal, financial, and family information required to accurately apply the correct body of laws to that individual's property which does not have legally binding instructions for its post-death ownership. Further, Moran fails to teach or to even contemplate a method to address circumstances in which the information which was provided prior to the individual's death is insufficient for purposes of determining the legal heirs and the legal distribution of that person's intestate property.

Although these laws apply to every intestate decedent, there has never been a product or method designed to correctly determine the legal distribution of intestate property upon the basis of an application of the individually unique personal, financial, and family facts associated with an intestate decedent to the pertinent laws. It would be advantageous, therefore, to provide a program that provides people with an accurate ascertainment of the legal distribution of a decedent's intestate property during the settlement of the decedent's estate.

### SUMMARY OF THE INVENTION

The present invention provides a system and method wherein the legal distribution of an individual's intestate property is ascertained upon the basis of an application of that individual's unique personal, family, and financial information to the applicable body of laws, as such information is provide by a user. This is accomplished by determining which of the information utilized by the applicable body of laws is absent and, of that absent information, which is the most necessary to making an ascertainment of the subject legal distribution, while soliciting, collecting, and examining a minimum quantity of such information.

Each body of intestate laws identifies and describes characteristics that define and classify persons and property for the purpose of establishing the distribution and ownership of the intestate property which is subject to those particular laws. According to one aspect of the invention, variables for use with computer readable code are created to represent, collect, store, and/or convey data defining the circumstances, conditions, facts, and/or concepts set forth by the text used within any individual body of laws as being required or useful to ascertaining the legal distribution of intestate property which is subject to that body of laws. These variables are arranged hierarchically according to the order of priority in which their data must be examined to determine the legal distribution in accordance with the requirements of the subject body of laws. This arrangement provides a means of ascertaining the legal distribution in accordance with the applicable laws of a jurisdiction through an examination of a lesser quantity of data that the total quantity that is described by those applicable laws.

A related innovation is the ability to reference and utilize the data represented by previously defined variables for the purpose of ascertaining the legal distribution of an individual's intestate property according to the laws employed by various, different jurisdictions, without deleting the data of variables which are not utilized by any particular jurisdiction at the time of its consideration.

For example, variables with data indicating 1.) the absence of a surviving spouse; 2.) the existence of a surviving California domestic partner; 3.) the absence of any living children; 4.) the absence of any deceased children; 5.) and the existence of a living parent are sufficient and necessary to ascertaining the legal distribution of an individual's intestate property that is subject to the jurisdiction of California. If the user who provides the data for these variables subsequently chooses the jurisdiction of Texas as applicable to some or all of the subject intestate property, the data which indicates the existence of a surviving California domestic partner will not be used in ascertaining the legal distribution. However, the variable created to represent a California domestic partner will retain that data which is already present.

Using this same scenario as an example, the data of the presently defined variables described above will be insufficient to ascertain the legal distribution according to the laws of Texas. In accordance with the present invention's system and method of ascertaining the legal distribution by means of an examination of a minimum quantity of data, definitions will be solicited for the variables representing the existence of any living siblings and the existence of any deceased siblings with living issue. If these variables are defined with data indicating the existence of one or more living siblings and the absence of any deceased siblings with living issue, no further data will be solicited. Although in specific circumstances, a decedent's living maternal aunt is entitled to a portion of an intestate distribution made in Texas, data will not be solicited to define the living maternal aunt variable because defining the living and deceased sibling variables provides while the present data indicates the existence of a living parent or prior to the defining of the living and deceased sibling variables.

Similarly, no additional data will be solicited if this user subsequently chooses any one of the jurisdictions of Alabama, Alaska, Arizona, Arkansas, California, Colorado, Connecticut, Delaware, Florida, Georgia, Hawaii, Idaho, Iowa, Kansas, Kentucky, Maine, Maryland, Massachusetts, Michigan, Minnesota, Montana, Nebraska, Nevada, New Hampshire, New Jersey, New Mexico, New York, North Carolina, North Dakota, Ohio, Oklahoma, Oregon, Pennsylvania, Rhode Island, South Carolina, South Dakota, Tennessee, Utah, Vermont, Virginia, Washington, Washington D.C, West Virginia, or Wisconsin, as the sole surviving parent is designated as the only heir of the legal distribution in each of these jurisdictions. As noted, the each of the previously defined variables will retain their respective data, despite the failure to utilize all of that data with these jurisdictions.

Accordingly, if the user subsequently chooses the any one of the jurisdictions of Illinois, Indiana, Mississippi, Missouri, or Wyoming, the legal distribution will be ascertained upon the basis of the data defining the variables which represent the absence of a surviving spouse, the existence of a living parent, the existence of a living sibling, and the absence of a deceased sibling with living issue, as described above and first defined based upon a consideration of the hierarchy of variables created for use with California laws and the hierarchy of variables created for use with Texas laws.

Accordingly, upon the selection of any jurisdiction for which a hierarchy of variables created has been created, the existing data represented by the presently defined variables is examined in accordance with the applicable hierarchy of variables to determine whether that existing data is sufficient to ascertain the legal distribution of intestate property that is subject to the laws of the currently selected jurisdiction.

Where the variables with user-defined values are not sufficient for this purpose, a value is solicited for the undefined data which is the most relevant and necessary to ascertaining the legal distribution, according to the method described above. Where the data is sufficient for this purpose, the necessary data variables are utilized to ascertain the legal distribution of the subject intestate property and provide output values to the user that detail the legal distribution of the subject intestate property upon the basis of those user-defined values.

Other features, benefits, and advantages of the present invention will be apparent from the accompanying drawings and from the detailed description which follow.

### BRIEF DESCRIPTION OF THE DRAWINGS

The present invention is illustrated by way of example, and not by way of limitation, in the figures of the accompanying drawings and in which like reference numerals identify like elements throughout the various figures and in which:

FIG. 1 is a block diagram representing a computer system into which the present invention may be incorporated;

FIG. 2 is a reproduction of Chapter 732, Part I, Section 732.102 and Chapter 732, Part I, Section 732.103 of the Florida Statutes.

FIG. 3 is an exemplary illustration of the parsing of Chapter 732, Part I, Section 732.102 into its operative portions;

FIG. 4 is an exemplary illustration of the Chapter 732, Part I, Section 732.103 into its operative portions;

FIG. 5 is an illustration of placing parsed legal text, a standard summary of that text, and an associated variable into a tabular format;

FIG. 6 is a simplified block diagram illustrating an embodiment of a data analysis system work flow;

FIG. 7 is a flow diagram illustrating a method of arranging variables hierarchally;

FIG. 8 is a flow diagram illustrating a system of determining the currently absent data which must be solicited from the user;

FIG. 9 is one embodiment of a user-interface displaying previously provided data and the solicitation of data;

FIG. 10 is one embodiment of a user-interface displaying previously provided data and the solicitation of user action;

FIG. 11 illustrates one embodiment of presenting the summary of the legal distribution of an individual's intestate property;

### DETAILED DESCRIPTION OF THE INVENTION

### Definitions

The following terms shall have the following meaning throughout the description and claims.

Body of Laws—laws, statutes, judicial opinions, administrative regulations, and all other materials utilized in the application or interpretation of any one or more subjects based upon a legal perspective and with respect to a particular jurisdiction.

Issue—all of the direct lineal descendants of an individual person, including, for instance, each person who is classified as that individual person's child, grandchild, great-grandchild, great-great-grandchild, and continuing without limitation.

Online—using a global or local computer network.

Personal Property—In a broad and general sense, everything that is subject of ownership, not coming under denomination of real estate. A right or interest in things personal, or right or interest less than a freehold in realty, or any right or interest which one has in movable things. Black's Law Dictionary, Special Deluxe 5.sup.th Edition, p. 1096

Real Property or Real Estate—Land, and generally whatever is erected or growing upon or affixed to land. Also rights growing out of, annexed to, and exercisable within or about land. A general term for lands tenements, and hereditaments; property which, on the death of the owner intestate, passes to his heir. Black's Law Dictionary, Special Deluxe 5.sup.th Edition, p. 1096

Variable—a named container for data and which can assume different values or states.

Website—a group of at least one related page, typically multiple pages, of data, having common ownership, accessible from a global computer network, e.g. the internet.

Webpage—a portion of a website with a distinct URL associated with a higher level URL. One or more webpages constitutes a website. Webpage is interpreted to include alternative forms including pop-up windows.

A system and method for ascertaining the legal distribution of intestate property is presented.

### An Exemplary Computer System

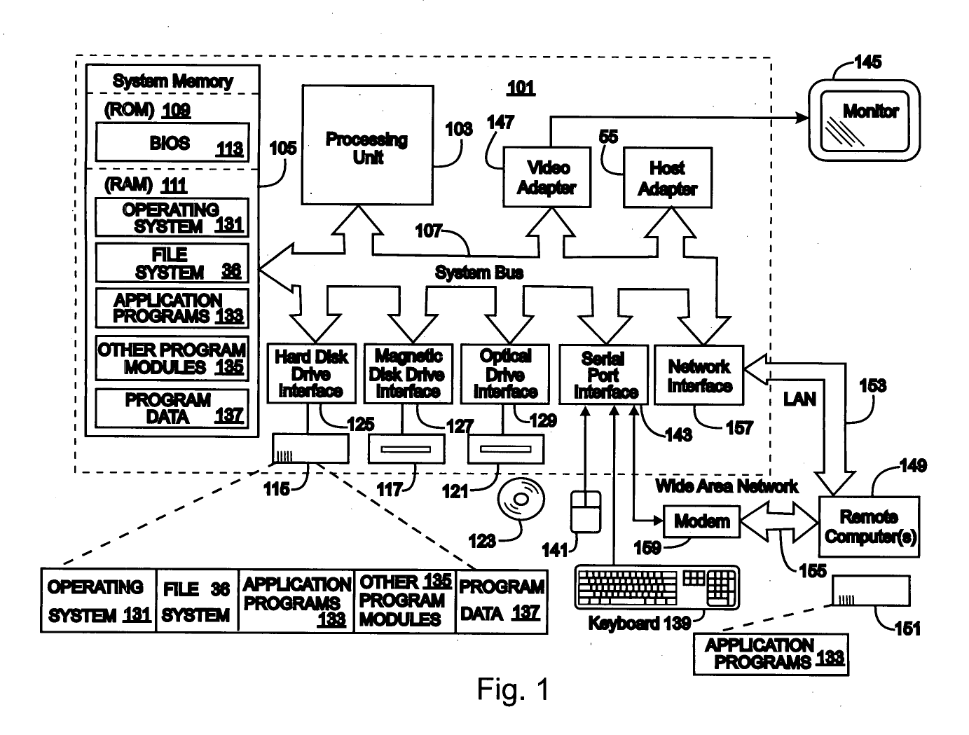

FIG. 1 and the following discussion are intended to provide a brief general description of a suitable computing environment in which the invention may be implemented. The invention will be described in the general context of computer-executable instructions, such as program modules, being executed by a personal computer. Generally, program modules include routines, programs, objects, components, data structures and the like that perform particular tasks or implement particular abstract data types. Moreover, those skilled in the art will appreciate that the invention may be practiced with other computer system configurations, including hand-held devices, multi-processor systems, microprocessor-based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

With reference to FIG. 1, an exemplary system for implementing the invention includes a general purpose computing device in the form of a conventional personal computer 101 or the like, including a processing unit 103, a system memory 105, and a system bus 107 that couples various system components including the system memory to the processing unit 103. The system bus 107 may be any of several types of bus structures including a memory bus or memory controller, a peripheral bus, and a local bus using any of a variety of bus architectures. The system memory includes read-only memory (ROM) 109 and random access memory (RAM) 111. A basic input/output system 113 (BIOS), containing the basic routines that help to transfer information between elements within the personal computer 101, such as during start-up, is stored in ROM 109. The personal computer 101 may further include a hard disk drive 115 for reading from and writing to a hard disk, not shown, a magnetic disk drive 117 for reading from or writing to a removable magnetic disk, not shown, and an optical disk drive 121 for reading from or writing to a removable optical disk 123 such as a CD-ROM or other optical media. The hard disk drive 115, magnetic disk drive 117, and optical disk drive 121 are connected to the system bus 107 by a hard disk drive interface 125, a magnetic disk drive interface 127, and an optical drive interface 129, respectively. The drives and their associated computer-readable media provide non-volatile storage of computer readable instructions, data structures, program modules and other data for the personal computer 101. Although the exemplary environment described herein employs a hard disk 115, a removable magnetic disk 119, and a removable optical disk 123, it should be appreciated by those skilled in the art that other types of computer readable media which can store data that is accessible by a computer, such as magnetic cassettes, flash memory cards, digital video disks, Bernoulli cartridges, random access memories (RAMs), read-only memories (ROMs), and the like may also be used in the exemplary operating environment.

A number of program modules may be stored on the hard disk 115, magnetic disk 119, optical disk 123, ROM 109, or RAM 111, including an operating system 131, one or more application programs 133, other program modules 135, and program data 137, with it also being possible to have any or all of the preceding located at remote computer or computers 149. A user may enter commands and information into the personal computer 101 through input devices such as a keyboard 139 and pointing device 141. Other input devices (not shown) may include a microphone, joystick, game pad, satellite dish, scanner, touch screen, or the like. These and other input devices are often connected to the processing unit 103 through a serial port interface 143 that is coupled to the system bus, but may be connected by other interfaces, such as a parallel port, game port, or universal serial bus (USB). A monitor 145 or other type of display device is also connected to the system bus 107 via an interface, such as a video adapter 147. In addition to the monitor 145, personal computers typically include other peripheral output devices (not shown), such as speakers and printers.

The personal computer 101 may operate in a networked environment using logical connections to one or more remote computers, such as a remote computer 149. The remote computer 149 may be another personal computer, a server, a router, a network PC, a peer device, or other common network node, and typically includes many or all of the elements described above relative to the personal computer 101, although only a memory storage device 151 has been illustrated in FIG. 1. The logical connections depicted in FIG. 1 include a local area network (LAN) 153 and a wide area network (WAN) 155. Such networking environments are commonplace in offices, enterprise-wide computer networks, Intranets, and the Internet.

When used in a LAN networking environment, the personal computer 101 is connected to the local network 153 through a network interface or adapter 157. When used in a WAN networking environment, the personal computer 101 typically includes a modem 159 or other means for establishing communications over the wide area network 155, such as the Internet. The modem 159, which may be internal or external, is connected to the system bus 107 via the serial port interface 143. In a networked environment, program modules depicted relative to the personal computer 101, or portions thereof, may be stored in the remote memory storage device. It will be appreciated that the network connections shown are exemplary and other means of establishing a communications link between the computers or between the computer system and any server or servers via a convention network infrastructure may be used.

### Parsing the Text of a Written Body of Laws

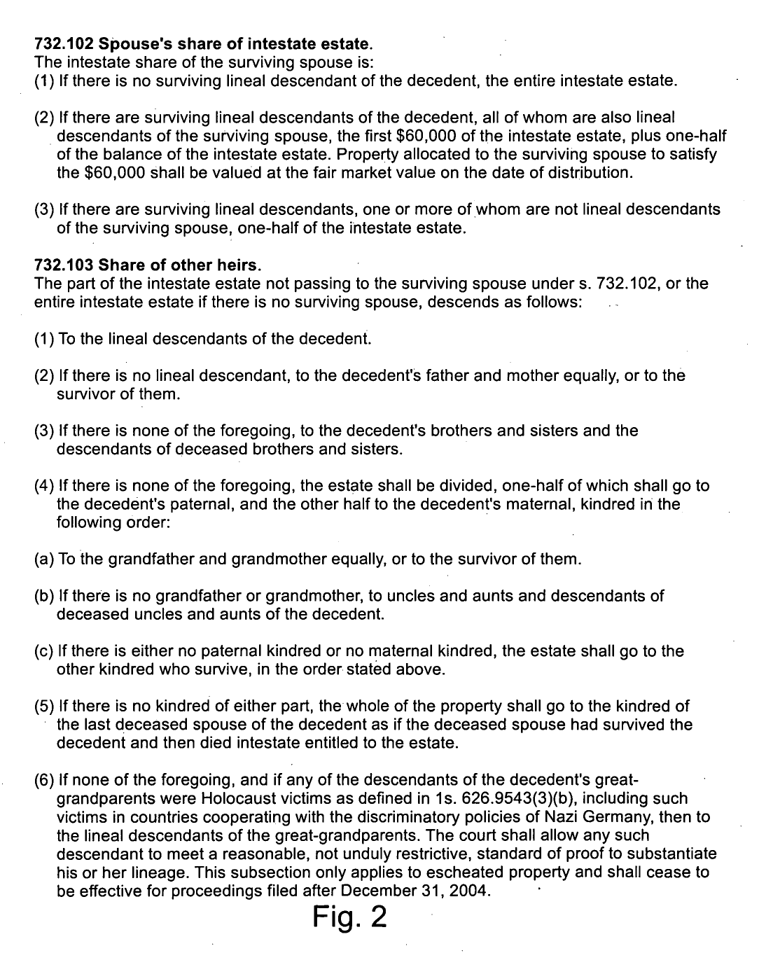

FIG. 2 reproduces the text of Chapter 732, Part I, Sections 732.102 and 732.103 of the Florida Statutes, which are respectively entitled “Spouse's share of the intestate estate.” and “Share of other heirs.” Although statutory text is presented for purposes of demonstration, it must be noted that the current invention is not limited to statutory text and may be used with every form of law, including statutory text, judicial opinions, and administrative materials. It must also be noted that the current invention is also not limited to the body of laws applicable to Florida's jurisdiction and may be used with any jurisdiction's body of laws related to a common theme or topic.

As shown by the statutory passages reproduced in FIG. 2, legal texts use words and phrases presented in a sentence or quasi-sentence format to describe and define the circumstances, conditions, facts, or concepts that are necessary to determining the subject matter which is relevant to that body of laws and, when relevant, the proper application of all or any aspect of that body of laws.

However, once the circumstances, conditions, facts, or concepts which are portrayed by the text of a body of laws are known and understood, it becomes possible to represent them with variables which may be subsequently defined with values that indicate the status or quality of such circumstances, conditions, facts, or concepts, as they pertain to the actual application of that body of laws.

In accordance with one aspect of the present invention, variables are created for the purpose of representing the data utilized by a body of laws to establish the legal distribution of intestate property subject to the jurisdiction to which that body of laws pertains. In order to create variables which are useful to establishing the relevance and proper application of a body of laws or of any portion of a body of laws, the text must first be categorized or parsed upon the basis of its operative portions.

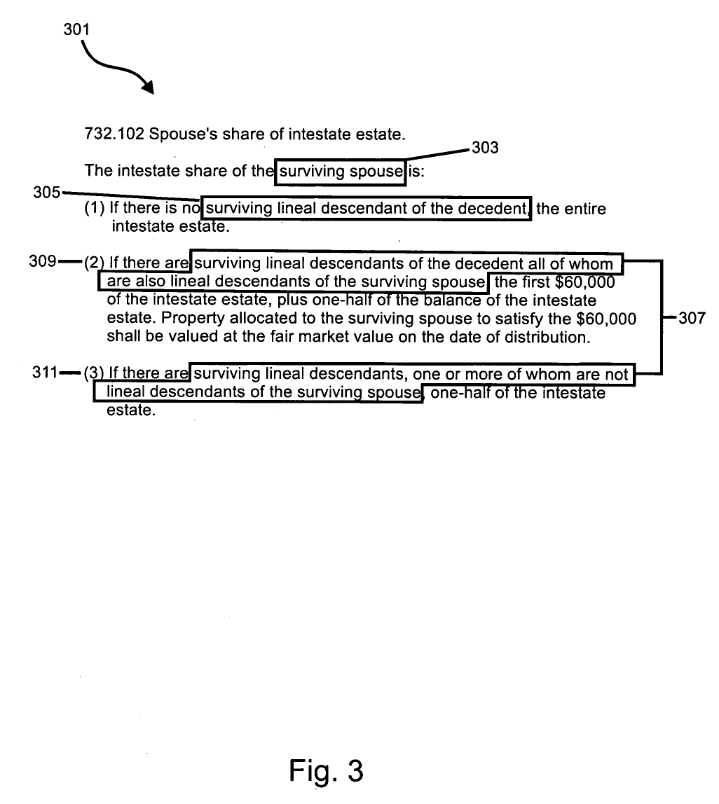

As depicted by FIG. 3, the text of Chapter 732, Part I, Section 732.102 of the Florida Statutes 301 generally describes three circumstances, conditions, or facts which are utilized to ascertain a surviving spouse's share of an intestate estate that is subject to Florida's jurisdiction. For purposes of demonstration, the words describing a single point of data that is operative to ascertaining the legal distribution of intestate property governed by Florida's jurisdiction have been labeled in FIG. 3. Although the creation of variables representing the operative portions of the relevant statutory text is necessary to the invention, it should be noted that the method of labeling depicted in FIG. 3 is provided as a basic tool in understanding the parsing of text into subject matter that is appropriate for use with a variable based upon the relation of that text to a single point of data; such labeling is not required with the actual implementation of the invention.

As shown by FIG. 3, the operative portions of the reproduced text reveal that ascertaining a surviving spouse's share of the intestate property subject to Florida's jurisdiction requires data indicating if:

1.) the decedent is survived by a spouse 303,

2.) the decedent has any surviving lineal descendants 305,

3.) all of the decedent's surviving lineal descendants are also lineal descendants of the surviving spouse 307.

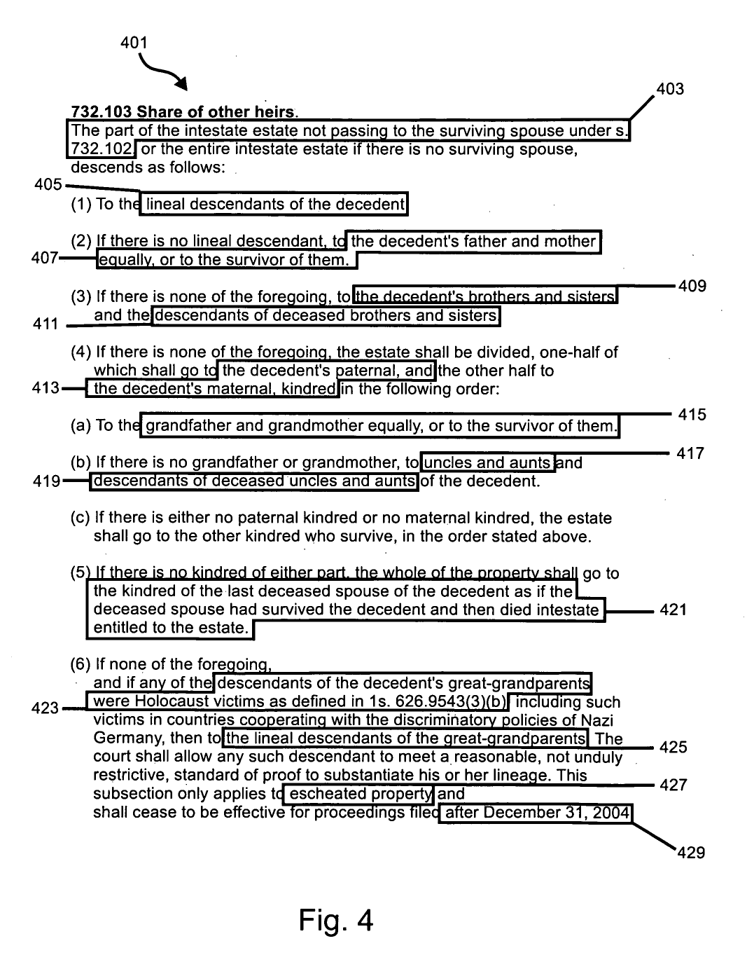

Also for purposes of demonstration, the same method of labeling depicted by FIG. 3 is depicted by FIG. 4. As shown, FIG. 4 reveals that the text of Chapter 732, Part I, Section 732.103 of the Florida Statutes 401 generally describes thirteen circumstances, conditions, or facts which are utilized to ascertain the legal distribution of that portion of an intestate estate that is subject to Florida's jurisdiction and which Chapter 732, Part I, Section 732.102 does not designate for distribution to a surviving spouse. More precisely, it is shown that determining the legal distribution of such intestate property requires data indicating if:

1.) any portion of the decedent's intestate estate does not pass to the decedent's surviving spouse according to Chapter 732, Part I, Section 732.102 of the Florida Statutes 403,

2.) the decedent has any surviving lineal descendants 405,

3.) either or both of the decedent's parents are surviving 407,

4.) the decedent has any surviving siblings 409,

5.) the decedent has deceased siblings with surviving descendants 411,

6.) either or both of the decedent's paternal or maternal 413 grandparents are surviving 415,

7.) the decedent has any surviving paternal or maternal 413 uncles or aunts 417,

8.) the decedent has any paternal or maternal 413 deceased uncles or aunts with surviving descendants 419,

9.) the decedent's most recent spouse predeceased the decedent with kindred who are presently surviving and who are entitled to take the intestate estate as heirs of that most recent spouse 421,

10.) any descendants of the decedent's great-grandparents were Holocaust victims, as defined in 1s. 626.9543(3)(b) of the Florida Statutes 423,

11.) any lineal descendants of the decedent's great-grandparents are surviving 425,

12.) there is any escheated property pertaining to the decedent 427,

13.) the decedent's estate proceedings were filed on or before Dec. 31, 2004 429.

### Creating Variables to Represent Parsed Text

After the subject text is parsed into its operative portions, the circumstances, conditions, facts, or concepts that are described by each parsed portion is determined for the purpose of creating a variable for the data which will represent the described subject matter.

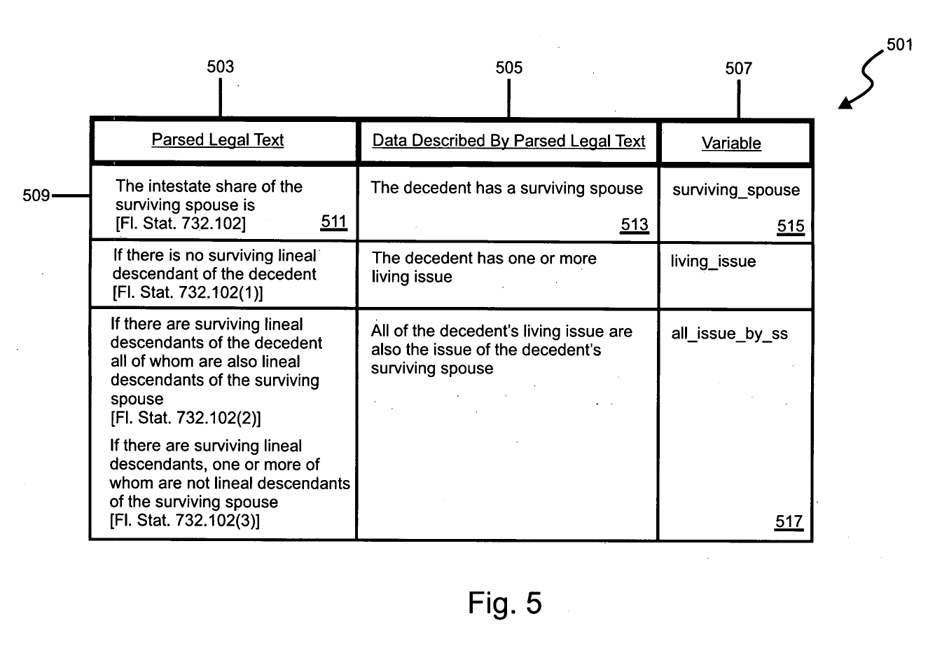

For purposes of demonstrating one method for accomplishing the creation of variables representing the circumstances, conditions, facts, or concepts described by parsed portions of legal text, FIG. 5 presents a table 501 comprised of three columns and three rows. As shown by the table 501, the data within each cell that is present within the same row is related to the same circumstance, condition, fact, or concept utilized when ascertaining the legal distribution of an intestate estate. For instance, the three cells comprising the top row 509 pertain to the decedent's surviving spouse, as shown by the upper left cell 511, top center cell 513, and upper right cell 515. Parsed portions of statutory text which describe a single circumstance, condition, fact, or concept utilized when ascertaining the legal distribution of an intestate estate are presented by the first column 503.

The second column 505 depicts one possible manner of otherwise describing the circumstance, condition, fact, or concept which is described by the parsed legal text located within the first column and within the same row. The text shown by the second column presents the parsed text in a format which is comprehensible outside of the context of the body of text from which the parsed text is derived. For instance, the parsed text reading “The intestate share of the surviving spouse is” 511 does not have a comprehensible meaning outside of the context of Chapter 732, Part I, Section 732.102 of the Florida Statutes. In contrast, the phrase “The decedent has a surviving spouse” 513 conveys an easily comprehensible fact which may be proven or disproven without any reference to a specific body of laws. Any phrase, fragment, or text which correctly describes the substance of the circumstance, condition, fact, or concept described by the adjacent cell within the first column may be used within the second column. For example, the phrase “The decedent has a surviving spouse” 513 could also be represented as “Surviving spouse?” or “Has surviving spouse” and achieve the same purpose.

Finally, the third column 507 depicts one possible name which may be used to identify the variable that must be created with respect to the circumstance, condition, fact, or concept described by the adjoining columns within the same respective row.

Those skilled in the art will recognize that variables created for use with machine readable code are typically identified by names that provide an indication of the data for which they are created, although such naming is not a requirement. Accordingly, as one example, a variable created with respect to data indicating if the decedent is survived by a spouse 515 may be given any one of the names “surviving_spouse” or “s_spouse” or “ss” without affecting its use or purpose. Similarly, this variable's use or purpose would not be affected if it is given any one of the names “a” or “one” or “xyz1” or any other character or set of characters assigned to that variable which is unique from the character or set of characters assigned to all other variables which may be utilized in conjunction with that variable. Named variables provided within the description of the invention are provided for purposes of illustration and do not limit the naming of any variable to that which is shown.

It should also be noted that the table 501 shown by FIG. 5 is provided as a tool in understanding a basic method for the creation of variables to represent the data described by the text of a body of laws by parsing that text into portions describing a unique circumstance, condition, fact, or concept, which may be represented by an individual variable created with respect to the collection, storage, and/or conveyance of data representing that same circumstance, condition, fact, or concept; the creation of variables upon this basis may be accomplished in any appropriate manner to achieve the desired result of collecting, storing, and/or conveying the unique circumstance, condition, fact, or concept described by the text of a body of laws without departing from the spirit of scope of the invention.

### Variable Representing Modifying Descriptors

The circumstances, conditions, facts, or concepts described by any parsed text may describe operative instructions which are used to modify or further define the circumstances, conditions, facts, or concepts that are described by other portions of parsed text. With reference to FIG. 4, it is shown that the parsed portions of 732.102(4) 413 describe data which indicates whether relations who fall within a defined class have a paternal or maternal relation to the decedent. Having one of these relations is an individual quality of the people who are described by the parsed portions of subsections 732.102(4)(a) 415 and 732.102(4)(b) 417, 419. Rather than create separate variables for the parsed portions of text which describe data that is used to modify or further define qualities of additionally described data, one variable is created for the modifying data and the modified data. For instance, one variable pertains to a living or deceased maternal grandmother, as opposed to one variable pertaining to a grandmother and a second variable pertaining to the quality of maternal. This provides conservation of resources that must be used in the solicitation and storage of defining values, as well as of the time that must be devoted to soliciting, collecting, and processing data.

In addition to maternal and paternal designations, further examples may also include, without limitation, such modifying data as date of death, slayer, parent's identity, half-blood relation, name, and address.

### Variable Representing Repeated Identical Facts

In addition to reducing the quantity of text that must be examined when ascertaining the legal distribution of an intestate estate, the use of variables reduces the quantity of data that must be solicited, provided, collected, examined, and processed by allowing operative circumstances, conditions, facts, or concepts which are duplicated and presented in different portions of the text of a body of laws to be represented by a single variable. Representation by a single variable provides a means for utilizing an assigned value at different occasions during the ascertainment of the legal distribution of an intestate estate, without requiring the solicitation of a value for that variable upon each occasion that the value must be referenced, saving time and maximizing the use of available resources.

With reference to FIG. 3, it is shown that the statutory text of 732.102(2) 309 and 732.102(3) 311 appear to present two separate factual circumstances for which data must be known. However, these subsections actually describe the same factual circumstance from alternate perspectives through the use of different language: the legal family relation between a decedent's surviving spouse and all of the decedent's surviving lineal descendants. For the purposes of creating a variable representing the data necessary to ascertain the legal distribution of an intestate estate, a single fact described by multiple portions of written text may be represented by a single variable without regard to the number of times the same factual circumstance is described by the text within that body of laws.

Using this method, subsections 732.102(2) 309 and 732.102(3) 311 are grouped and identified as one element 307 in FIG. 3 and described by the same individual variable “all_issue_by_ss” 517, as shown in FIG. 5. A reading of these statutory excerpts reveals that this duplicative presentation is utilized to describe the different shares of the intestate estate which are assigned to a surviving spouse based upon the surviving spouse's family relation with the decedent's surviving descendants. However, for purposes ascertaining the legal distribution of an intestate estate, the fact of the surviving spouse's family relation with the decedent's surviving descendants may be portrayed as a single item of data that is represented by a single variable. The same method may be used to portray multiple items of data that are collected in relation to a common fact, such as a variable that indicates the presence of absence of any living persons who are related to the decedent through either or both of his or her maternal or paternal grandparents.

### Data Format

The data used with any variable may be represented in any format which permits machine readable code to differentiate, identify, utilize, and process the information associated with that variable. Where a variable is created to represent one of multiple possible qualities or states, such as a jurisdiction or state of marriage, the format of its data may be represented as any non-duplicating value which are associated with each of the described qualities or states, such as “Maryland” and “Virginia”; “1” and “0”; “a” and “b”; or “yes” and “no”, with the same result. Where a variable is created to represent one of only two possible qualities or states, the data may be also be represented in a boolean format. Variables created to represent quantity will preferable use a numerical data format, permitting such data to be utilized in the performance of the mathematical calculations necessary to ascertaining the legal distribution of intestate property.

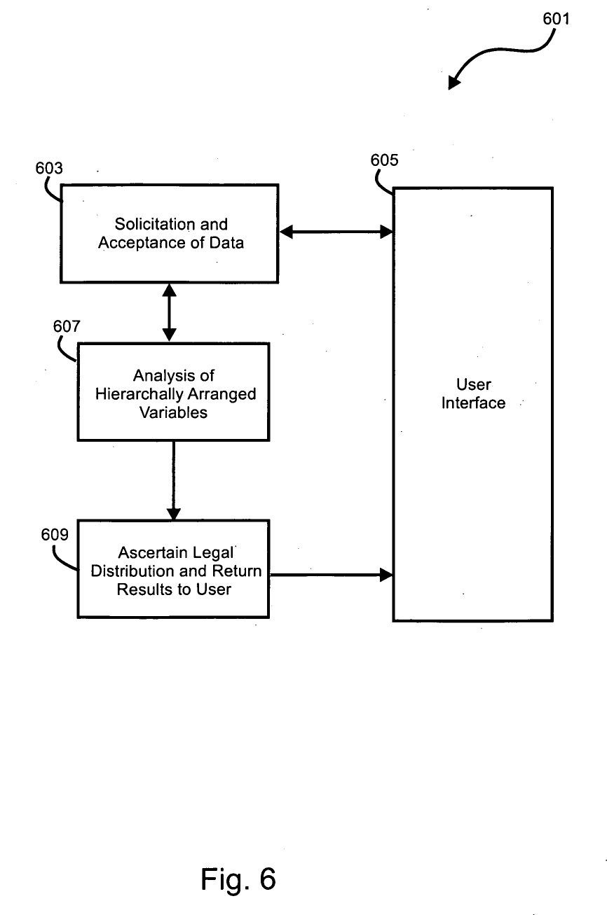

FIG. 6 is a simplified block diagram illustrating a data collection, analysis, and reporting system 601 in which one embodiment of the present invention may be used. Generally, the system 601 includes a module for the solicitation and collection of data 603, which receives input data from the user interface 605 and provides data to the user interface that communicates and describes the information that is being currently solicited 605. According to the embodiment depicted, the system 601 further includes a module for the analysis of hierarchally arranged variables and a module that ascertains the legal distribution of the subject intestate property 607, prepares a report of the dollar value of the subject property that each identified heir is entitled to receive, and returns the report to the user 609.

### Hierarchal Arrangement of Required Data by Intercomparison

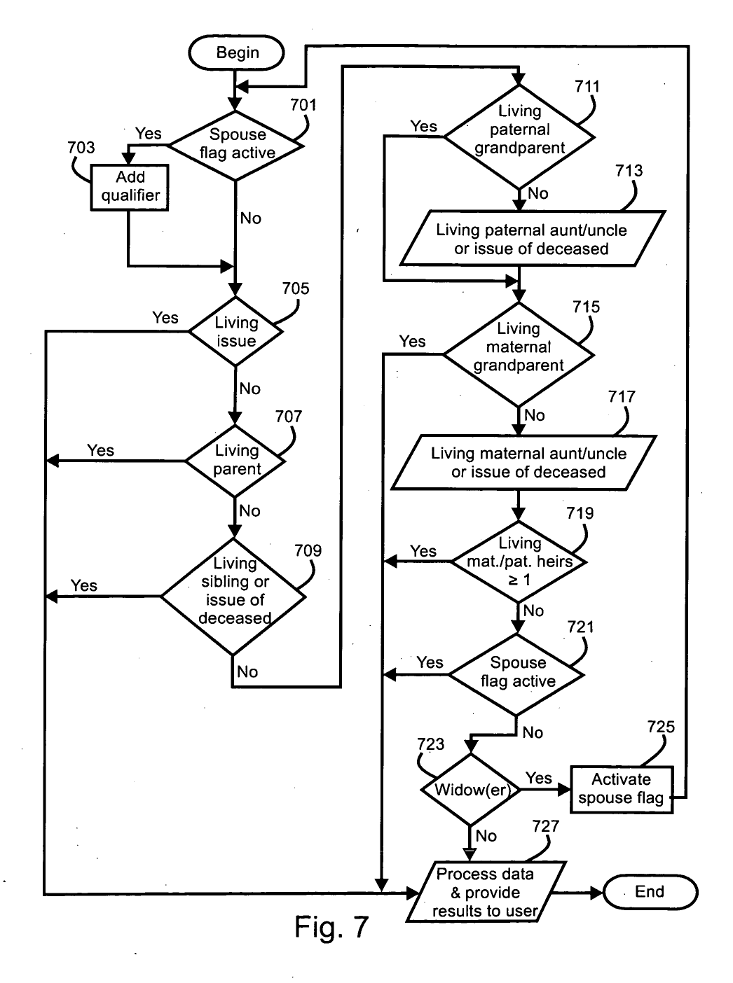

FIG. 7 is a flow diagram illustrating a system and method for utilizing only the most immediately relevant data required to ascertain the legal distribution of the net intestate estate governed by the jurisdiction of Florida, with respect to proceedings filed after Dec. 31, 2004. It will be noted that although the flow diagram presented by FIG. 7 depicts a system and method applicable to the laws of Florida, this flow diagram is also applicable and may be used with additional jurisdictions with or without the modification or additional of certain steps. For instance, Hawaii, New Jersey, New York, North Carolina, and Pennsylvania are jurisdictions that will use this flow diagram with a modification of step 721 to indicate that the spouse flag is active upon the first examination of step 721, causing the program to proceed from step 721 to step 727 without a prior examination of step 723 or step 725. This described modification may also be achieved by the elimination of all or any one of steps 701, 703, 721, 723, and 725 with the same result.

It is also important to note that while there are similarities between certain aspects of bodies of intestate laws used by the American jurisdictions, at present, the body of laws used by each jurisdiction is different from the body of laws used by every other jurisdiction. It will also be appreciated by one having ordinary skill in the art that each jurisdiction's body of laws is fluid and subject to change at any time or times, making the creation of a static and unchanging arrangement of the required data impracticable and not useful. Accordingly, a system and method for organizing the required data into a hierarchal arrangement based upon the priority of each item of required data, as determined by its usefulness to the ascertainment of the legal distribution is described and the illustration presented by the flow diagram at FIG. 6 is displayed for guidance, which will be appreciated and useful by one having ordinary skill in the art.

The creation of a flow diagram applicable to any particular desired body of laws is described herein, which permits one having ordinary skill in the art to create a flow diagram for any jurisdiction which is not illustrated herein.

The flow diagram at FIG. 7 is comprised of a hierarchal arrangement of the order in which the variables defining the necessary circumstances, conditions, facts, and/or concepts described by the text of Florida's laws must be examined. The order of arrangement assigned to any given variable is defined relative to all other variables, being based upon the priority of each variable's data to the ascertainment of the legal distribution.

The priority of each variable's data is determined by the ability to utilized that data to ascertain the legal distribution by the collection and evaluation of the least quantity of data that is required. Although each body of laws describes multiple circumstances, conditions, facts, or concepts pertaining to the data that is utilized in ascertaining the legal distribution of intestate property, it is frequently possible to make such an ascertainment without defining all of the described data.

For instance, in the typical distribution scheme, the decedent's issue are designated to receive the intestate estate in preference to the decedent's siblings. Once it is known that there is at one living person who is classified as the issue of the decedent, it becomes unnecessary to collect and process data indicating whether the decedent also has any living siblings. According to this same distribution scheme, it becomes similarly unnecessary to collect and process any data for those relations designated to receive the intestate estate only in the absence of issue and siblings once it is known that there is at least one living issue. Therefore, the variables with data pertaining to the decedent's issue are assigned a higher priority than the variables with data pertaining to the decedent's siblings.

Upon reaching step 705 shown by FIG. 7, the existing data of the variables pertaining to the decedent's issue is tested to determine whether the decedent is survived by one or more issue. If there is data present which indicates the existence of at least one surviving issue, steps 707 through 725 are precluded as unnecessary to the ascertainment of the legal distribution of the subject intestate estate and the program proceeds to step 727. If, however, the variables at step 705 are undefined, the absent data that is the most immediately relevant and necessary to determining the applicability of that step must be determined.

### Hierarchal Arrangement of Required Data By Intracomparison

The individual level of relation any person has with the decedent is the personal term or phrase that is used with reference to just one person, such as “sister” or “mother”. By comparison, the class of relation any person has with the decedent is general term or phrase that is used to with reference to a group of people who have the same individual level of relation with the decedent, such as “sibling” or “parent”. Where the same term or phrase may be used to describe either an individual or a class relation, the context of its use will determine the appropriate and intended definition.

Just as different classes of relation are granted priority over other classes of relation, the individual levels of relation within any respective class of relation may be granted priority over other individual levels of relation within the same class. For example, the class defined as issue will typically have priority over the class defined as siblings, meaning that any issue will be designated to take a share of the intestate property prior to any sibling. Similarly, within the class of siblings, a living sister is given priority over the decedent's living nieces and nephew who are the children of that sister. An intraclass hierarchal arrangement of the data required within each respective class of relation is created according to each respective class member's priority to receive a share over any other member of the same class based upon each class member's individual level of relation. For example, within the class of “issue”, the Family Level Listing will be comprised of the following levels arranged in the following order:

1.) Child;

2.) Grandchild;

3.) Great-grandchild;

4.) Great-great-grandchild;

5.) Great-great-great-grandchild.

Similarly, within the class of “sibling”, the Family Level Listing will be as follows:

1) Sibling;

2.) Niece;

3.) Grandniece;

4.) Great-grandniece;

5.) Great-great-grandniece;

6.) Great-great-great-grandniece

These hierarchal arrangements also permit a determination of the most relevant and absent data that must be solicited from the user, with the purpose of soliciting and collecting the minimum quantity of necessary data.

Each individual class member's priority is established by the applicable body of laws, with such priority typically being organized in successive order according to the proximity of each individual level of relation to the decedent according to the degrees of kinship defined by each respective jurisdiction.

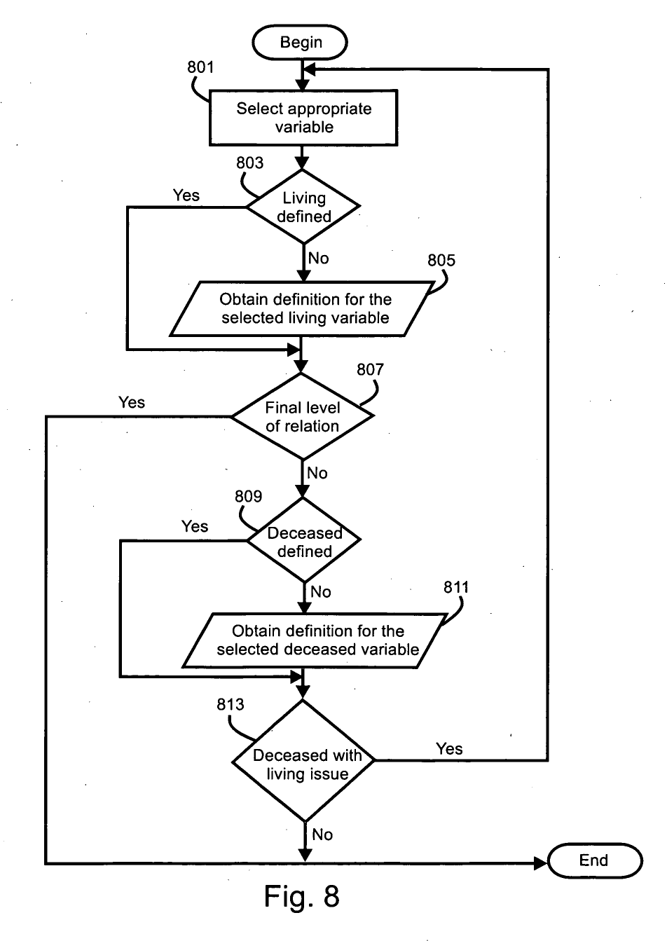

FIG. 8 illustrates a system and method for determining which undefined variable representing an individual level of relation within any respective class of relation will provide the data that is the most immediately relevant and necessary to ascertaining the distribution.

Each step used in the hierarchal arrangement of variables representing all of the required data which defines a class of relation requires an evaluation according to the system and method shown by FIG. 8. With respect to the illustration presented by FIG. 7, these steps are 705, 707, 709, 711, 713, 715, and 717.

For example, when the data at step 705 is undefined, the Family Level Listing utilized by step 801 will contain the possible levels of relation that describe the people who may be within the class of relation comprised of the decedent's issue.

Final Qualified Relation within a Class of Relation

To maintain consistency with the subject of prior examples, the illustration of an application and use of a Family Level Listing will be described with regard to Florida, without the intention of limiting the invention's scope to Florida.

Intestate property subject to Florida's jurisdiction is distributed among qualified heirs according to the per stirpes system. In accordance with this system, those individuals who are more closely related to the decedent within the same class of family relation are considered prior to those who are not as closely related within the same class. For instance, when examining the “issue” or “lineal descendant” class or relation, children are considered before grandchildren, who are similarly considered before great-grandchildren, and so on.

To account for the requirements of the per stirpes system, the Family Value Listing utilized by step 801 with this illustration is comprised of the following levels of relation within the “issue” class of relation, in the presented order of priority: 1.) Child; 2.) Grandchild; 3.) Great-grandchild; 4.) Great-great-grandchild; and 5.) Great-great-great-grandchild.

Step 801 selects the first item from the applicable Family Value Listing, which is then used to determine which variables describing people with the same level of relation must be selected and examined for a definition.

For instance, where Child is selected from the listing, it is determined that the variables defining the living children and defining the deceased children with living issue must be examined for values. The defining values for these variables are stored at and accessible via the RAM 111, hard disk drive 115, magnetic disk drive 117, optical disk drive 121, and/or remote computer(s) 149.

Once retrieved from the appropriate source, step 803 examines the variable pertaining to the living members of the current level of relation to determine whether is defined. If undefined, step 805 solicits a defining value from the user via the user interface 605. If the variable pertaining to the currently applicable living members is defined with a value at the time it is examined at step 803, step 805 is not used to solicit any data from the user.

Following a confirmation of a variable's definition at step 803 or at step 805, step 807 determines whether that variable represents the final level of relation that may be a potential heir within that class of family relation.

The per stirpes system of distribution also uses the sum of the number of living relations and the number of deceased relations who have living issue within the same class of relationship when calculating the shares of the intestate property, making it necessary to distinguish between the living and the deceased at each degree of relation.

When considering the living and the deceased persons with the same relation to the deceased at any given class of relationship, neither has priority as being classified as the most immediately relevant data and either may be solicited for completion first. However, the data for deceased class of persons will always take priority over the closest class of living persons immediately below that deceased class on the listing, as knowing the status of deceased persons with living issue may preclude the necessity of data pertaining to those issue. Although there may be deceased persons at any level of relation, only those with living issue are pertinent to ascertaining the distribution of the intestate estate. For instance, when it is known that there are not any deceased siblings with living issue, it becomes unnecessary to solicit and examine data pertaining to nieces and nephews.

### Determining Final Level of Relation

A final level of relation that is classified as a potential heir may be defined by the scope of the listings within any respective Family Level Listing, rather than being explicitly defined by the subject body of laws. Due to the various systems of representation for deceased heirs used by American jurisdictions, each class of family relation must have a variable which is designated as the final level of relation that may receive a definition, even though the body of laws for the applicable jurisdiction may not make such a distinction.

As described earlier, many American systems of representation for deceased heirs hypothetically extend indefinitely to the surviving issue of those deceased heirs until the intestate property has been entirely distributed, making it impossible to create a fully comprehensive listing of every potential heir described by the laws. In these circumstances, the final level of relation is chosen upon the basis of creating a Family Level Listing that is likely to apply to the greatest number of circumstances.

For instance, “great-great-great-grandniece” may be chosen as the final level of relationship within the Family Level Listing used with the sibling class of relation for any jurisdiction which does not otherwise impose a prior limitation. However, the Family Level Listing for any jurisdiction that extends beyond the great-great-great-grandniece level of relation, the final level of relationship could be “great-great-great-great-great-great-grandniece” or any additional level extending to a more distant level of relation without any regard to how unlikely it may seem that such level of relation will be used.

Continuing to use Florida for purposes of illustration, an examination of the sibling class of family relation will be used to demonstrate the application of step 807 with a body of laws that does not define a final level of relation. According to this illustration, the final level of relation in the Family Level Listing is defined with the value “great-great-great-grandniece”. This level is chosen as a level which is likely to apply to the greatest number of circumstances, but is not a level of relation that Florida's body of laws define as the final level of relation which is qualified to receive a share of the intestate property by representation of a deceased heir. As to the sibling class of family relation, Florida's body of laws does not define a final qualified level of relation.

With each instance that step 807 becomes active with this type of jurisdiction, the Family Level Listing is examined to determine whether there is a level presented in successive order after the item most recently chosen from the Family Level Listing at step 801. If another item is present, step 809 examines the variable pertaining to data that represents deceased members of the same level of relation defined by the item most recently chosen from the Family Level Listing. If Family Level Listing does not have another item listed subsequent to the item most recently chosen from the Family Level Listing, the program is ended.

Using the current example, where the most recently chosen item is “niece”, step 807 will determine that the item “grandniece” is present at one successive level beneath “niece” on the Family Level Listing and will proceed to step 809. Where the most recently chosen item is “great-great-great-grandniece”, step 807 will determine that no additional items are present in the listing subsequent to “great-great-great-grandniece” and will end.

This system and method will is also applicable where the final level of relation is defined by the appropriate body of laws, but without limitation based upon the existence of a more closely related surviving heir.

### Final Level of Relation Determined by Body of Laws

A last level of relation may also be dictated by the applicable body of laws in a manner that defines a final level of relation as being qualified to receive a share only where more closely related individuals are not living. When there is living member among the class of more closely related individuals, the final level of relation is not the last item listed in the Family Level Listing. According to these requirements, examining the Family Level Listing for the presence of an item subsequent to the present item is not effective in determining whether the final level of qualified heir has been reached.

For instance, Pennsylvania's body of laws defines first cousins once-removed as the most distant level of relation that may qualify to receive any intestate property, but only in instances where there are not any living members of the aunt level of relation or of the first cousin level of relation. These limitations are defined by statutory law as:

“ . . . no issue of a child of an uncle or aunt of the decedent shall be entitled to any share of the estate unless there be no relatives as close as a child of an uncle or aunt living and taking a share therein, in which case the grandchildren of uncles and aunts of the decedent shall be entitled to share, but no issue of a grandchild of an uncle or aunt shall be entitled to any share of the estate.” 20 Pa.C.S. §2104(1).

Stated in another manner, a first cousin once-removed can receive a portion of the intestate share designated for the decedent's deceased aunt or uncle, but only when there isn't at least one living first cousin, living aunt, or living uncle of the decedent.

According to the requirements of these types of laws, a formula in the format of a conditional statement is used at step 807 to determine whether the variable that is being examined is designated as the variable representing the final level of relation within the currently applicable Family Level Listing. The basic format for a conditional statement determining the attainment of such a final level of relation is as follows:

```
if ($relation_level == “y”) {
  if ($current_value >= 1) |51 (y == z){
    $reached_last = 1;
  }
  elseif (y != z) && ($base_level == 0){
    y = z
  }
}
return $reached_last;
```

The variables $relation_level, and $reached_last are defined in the same manner and with the same purpose as previously described. The variable “z” is defined with a value representing the last qualified level of relation that may take a portion of the intestate property by representation of a deceased ancestor, subject to the failure of the preceding classes to contain at least one living member. This value is determined upon the basis of being the final item in the Family Level Listing. The value of “y” is chosen as the final level of relation that must not contain any living members in order for the level of relation represented by the value of “z” to become potentially eligible to receive a share of the intestate estate, which is assigned by designation of a variable created for that purpose and associated with the Family Level Listing. Continuing to use Pennsylvania for purposes of illustration, the value of “y” is defined with the value “first cousin” and “z” is defined as “first cousin once-removed” when the Family Level Listing is first consulted at step 801.

The variable $current_value is used to evaluate the current number of living members represented by the item currently selected from the Family Level Listing, where that item matches the value of “y” as determined by its defining of $relation_level. A definition for $current_value is derived or obtained from the value provided by the user in response to a solicitation for data indicating how many living members of that class exist. Although represented numerically in the above example, any data format may be used which can convey information indicating the existence of at least one living member when applicable.

The variable $base_level is defined with the value indicating the existence of at least one living member within the level of relation that precludes all members of the last level of relation defined by the listing, despite the absence of any members of the class that presently defines “y”.

As Pennsylvania denies a share of the intestate property to first cousins once-removed where there is a living member of the first cousin or the aunt level of relation, when the value of $last_level is defined as first cousin, the value of $base_level is defined as aunt.

When the current item from the Family Level Listing is first cousin, the value of $relation_level is also first cousin and the conditional statement that evaluates the values of $current_value, “y”, and “z” is examined. If either portion of the conditional statement is true, $reached_last is used to designate the current level as being the final level and step 807 proceeds to the end. If, however, both conditionals are false, the value of $base_level is evaluated to determine whether there are any living members of the class preceding the class represented by the current $relation_level value, such that solicitation of data pertaining to the class represented by the value of “z” is unnecessary.

It is noted that although the illustration references the use of a number which represents a quantity with respect to the defining value of the $current_value variable, the defining value may be of any data type and is not restricted to a numerical value. Accordingly, the target value of the variable $current_value may be assigned any arbitrarily chosen and unique value that will be tested for attainment or equality by the formula. For instance, a value of “YES” could be assigned as the target value, with the formula merely testing the whether the value of $current_value is equal to “YES” at each instance that the formula requires the testing of this variable.

Although the exemplary format of the formula used at step 807 described herein employs PHP standards, it should be appreciated by those skilled in the art that other types of languages which employ defined variables and which may be read and processed by a computer, such as JavaScript, AJAX, Visual Basic, and the like may also be used in the exemplary formula.

### Display of Information

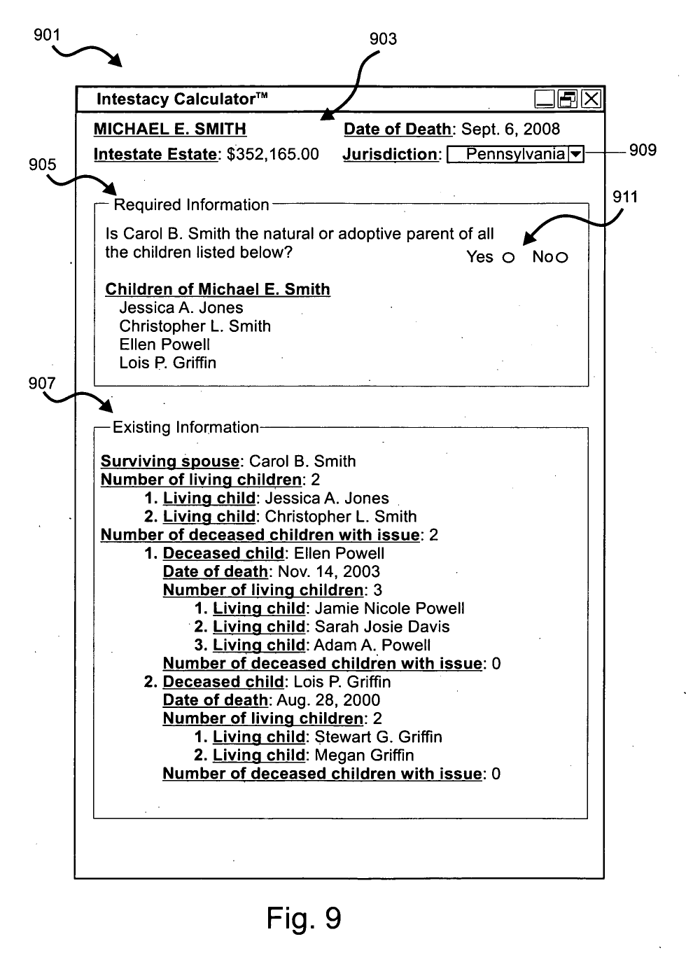

The user interface 605 is used to convey or express information to the user based upon the currently provided data, as well as solicit required information from the user. FIG. 9 illustrates a user interface screen 901 according to one embodiment of the present invention. The user interface screen includes three separate areas: 1.) an area 903 for displaying previously entered data describing basic facts pertaining to the decedent, 2.) an area 905 for soliciting data from the user and allowing the user to provide the data, and 3.) an area 907 for displaying the previously entered data pertaining to all required information not displayed in the area 905.

Area 903 displays pertinent facts describing the subject decedent in a prominent position in comparison to the general screen and all in one place for easy reference. This area 903 also provides a means which allows the user to choose data items for updating. As is common practice, underlined text presented with an interactive program refers to areas which may be chosen for further information or action. Choosing any underlined item present in area 903 or area 907 displays a means in area 905 for altering that data as it currently appears.

According to the embodiment depicted, an input system is provided in area 903 which is comprised of a drop down menu 909 and an input system is provided in area 905 which is comprised of radio buttons 911. However, various means of accepting user input, such as a text box or push button, will be provided as appropriate to the data that must be input by the user.

The data regarding the existence of family members that is solicited from the user within area 903 is determined at step 805 and step 811, as such is respectively determined to be required. Additional data, such as that pertaining to the decedent's status as a widow or widower shown by step 723 of FIG. 7, is determined by various, respective steps of the hierarchal arrangement of variables defining the necessary circumstances, conditions, facts, and/or concepts of the currently applicable jurisdiction. In each instance that absent data is required for the operation or function of any system or method, that data is obtained from the user via the user interface by a request from the system or function which will process the completed values.

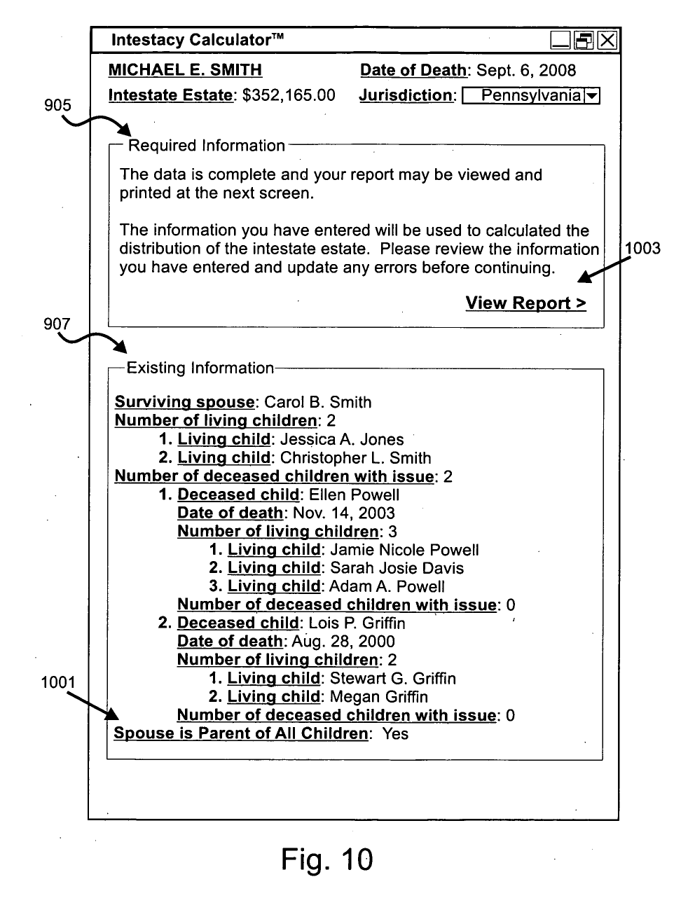

As shown by FIG. 10, area 907 is updated with the data provided by the user 1001 at area 905 upon the entry of that data. As solicited data is accepted 603 and analyzed 607, the content displayed at area 907 of the user interface 605 is modified according to the various analyses performed 607 which require the solicitation of additional data from the user 603 via the users interface 605 or the ascertainment of the legal distribution of the subject intestate property and presentment of the results to the user 609 via the user interface 605.

FIG. 10 depicts the display of information at area 905 based upon the analysis of the most recent data provided at area 905. As depicted, area 905 illustrates one manner of providing data which informs the user that the current information is sufficient to ascertain the legal distribution of the intestate property rather than the solicitation of data, with area 905 displaying this status together with instructions and a means 1003 to access and view the reported data.

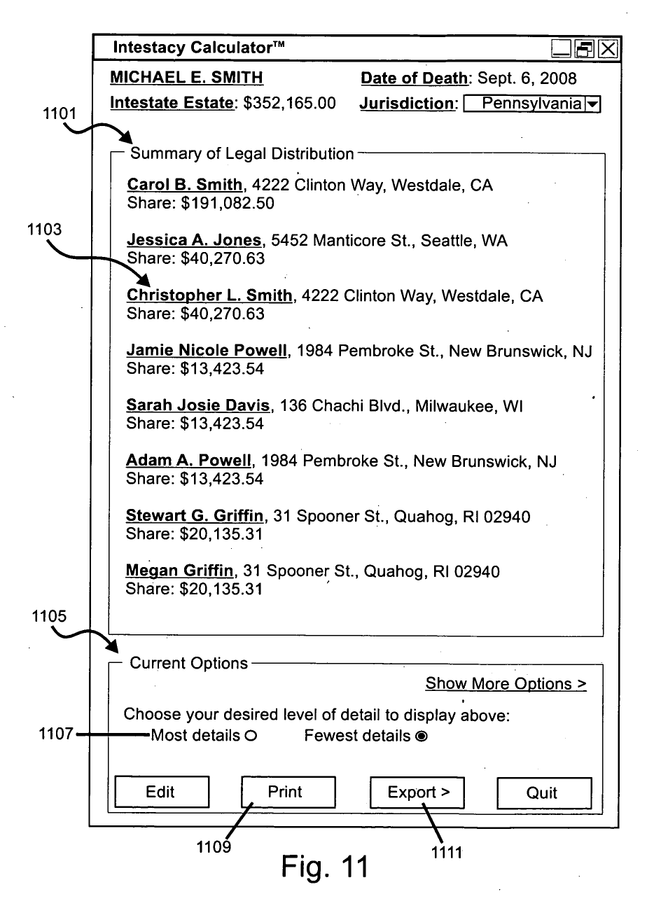

FIG. 11 depicts one format of presenting a summary of the legal distribution of the subject intestate property 1101 upon the basis of the user-provided data. This form of summary 1101 displays the individual name, contact information, and legal share of the subject intestate property 1103, allowing the user to precisely associate each heir's respective legal share with the appropriate person. An area comprised of options 1105 applicable to the currently displayed summary 1101. The user is provided with a means to display additional details 1107 relating to each displayed individual and relating to the subject intestate property, such as each person's relation to the decedent, the state death tax rate imposed against each person, and the value of the state death tax owing against each person's share, if any. The user is provided with a means to print 1109 the currently displayed data to a sheet or sheets of paper through the use of a local or remote printer which is otherwise available to the system employed by the user to access and view the displayed summary 1101. The user is also provided with a means to export the data 1111 which is present in the displayed summary 1101 to any third-party program designed to process all or a portion of the data in relation, which may be for the purposes of preparing additional paperwork during the settlement of the estate for a decedent or in the preparation of materials relative to the estate planning of a living person.

In the foregoing specification, the invention has been described with reference to the specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A computerized method for ascertaining the legal distribution of an individual's intestate property, comprising:
(a) accepting input to define a plurality of variables, said variables being designed for use with data defining at least one data item described by the body of laws controlling the said legal distribution and required to ascertain said legal distribution;
(b) providing a hierarchical arrangement of said variables, said hierarchical arrangement being substantially ordered in a manner permitting the collection of less than the full quantity of data described by the applicable body of laws;
(c) means for analyzing the said variables and determining the presence or absence of sufficient defining values existing among said all variables for the purpose of ascertaining said legal distribution;
(d) means for determining the undefined variable existing in said hierarchical arrangement which has priority over the remaining undefined variables existing in said hierarchical arrangement according to the order of said undefined variables;
(e) means for soliciting a value for said undefined variable;
(f) means for analyzing a predetermined set of said defined variables and determining the presence or absence of sufficient defining values existing among said set of defined variables for the purpose of defining an independent variable with a defining value collectively representing the defining values of all defined variables comprising said set of defined variables;
(g) means for determining those of the said defined variables which are not necessary to performing the said ascertainment of the legal distribution;
(h) analyzing the said variables representing sufficient data for the purpose of ascertaining said legal distribution;
(i) means for outputting the result on a display which provides the distribution of the said intestate property according to the dollar value of each interest assigned to each legal heir,
whereby the user may deliver the legally required value of the intestate property to the legally designated heirs of the intestate property.

2. The method of claim 1 wherein input is accepted from a user interface.

3. The method of claim 1 wherein input is accepted from another application.

4. The method of claim 1 wherein an analysis of the said variables to determine the presence or absence of sufficient defining values existing among said all variables for the purpose of ascertaining said legal distribution.

5. A computer program product comprising a computer-readable storage medium storing computer-executable instructions such that when executed, implement a method comprising:
(a) accepting input to define a plurality of variables, said variables being designed for use with data defining at least one data item described by the body of laws controlling the said legal distribution and required to ascertain said legal distribution;
(b) providing a hierarchical arrangement of said variables, said hierarchical arrangement being substantially ordered in a manner permitting the collection of less than the full quantity of data described by the applicable body of laws;
(c) means for analyzing the said variables and determining the presence or absence of sufficient defining values existing among said all variables for the purpose of ascertaining said legal distribution;
(d) means for determining the undefined variable existing in said hierarchical arrangement which has priority over the remaining undefined variables existing in said hierarchical arrangement according to the order of said undefined variables;
(e) means for soliciting a value for said undefined variable;
(f) means for analyzing a predetermined set of said defined variables and determining the presence or absence of sufficient defining values existing among said set of defined variables for the purpose of defining an independent variable with a defining value collectively representing the defining values of all defined variables comprising said set of defined variables;
(g) means for determining those of the said defined variables which are not necessary to performing the said ascertainment of the legal distribution;
(h) analyzing the said variables representing sufficient data for the purpose of ascertaining said legal distribution;
(i) means for outputting the result on a display which provides the distribution of the said intestate property according to the dollar value of each interest assigned to each legal heir,
whereby the user may deliver the legally required value of the intestate property to the legally designated heirs of the intestate property.

6. The method of claim 5 wherein input is accepted from a user interface.

7. The method of claim 5 wherein input is accepted from another application.

8. The method of claim 5 wherein an analysis of the said variables to determine the presence or absence of sufficient defining values existing among said all variables for the purpose of ascertaining said legal distribution.
